(19) United States
(12) Patent Application Publication
(10) Pub. No.: US 2015/0180775 A1
(43) Pub. Date: Jun. 25, 2015

(54) Communication System, Control Apparatus, Communication Method, and Program

(71) Applicant: NEC Corporation, Tokyo (JP)

(72) Inventor: Yohei Hasegawa, Tokyo (JP)

(21) Appl. No.: 14/412,977

(22) PCT Filed: Jul. 5, 2013
(86) PCT No.: PCT/JP2013/004188

§ 371 Date: Jan. 5, 2015

(30) Foreign Application Priority Data
Jul. 6, 2012 (JP) 2012-152065

(51) Int. Cl. H04L 12/741

(52) U.S. Cl. CPC H04L 45/74

(57) ABSTRACT

A control apparatus is connected to the network and includes: a switch control unit controlling the second switch; a path examination unit determining whether communication from an arbitrary source connected to the network uses a plurality of paths; and an erroneous learning prevention processing unit executing, when a merging point of the plurality of paths is the first switch, a predetermined erroneous learning prevention process. Occurrence of a loop or route flapping is prevented in a network environment including both a switch having an address learning function and a switch without such function.

### FIELD

The present invention is based upon and claims the benefit of the priority of Japanese patent application No. 2012-152065, filed on Jul. 6, 2012, the disclosure of which is incorporated herein in its entirety by reference thereto. The present invention relates to a communication system, a control apparatus, a communication method, and a program. In particular, it relates to a communication system, a control apparatus, a communication method, and a program for realizing communication via a network including both a switch that executes an operation of learning a packet destination based on the source address of an incoming packet and determining the destination of the next incoming packet based on a result of the learning and a switch that does not execute such operation.

### BACKGROUND

Networks using the Internet, data centers, supercomputers, etc. have been expanding. Accordingly, it is becoming more difficult to ensure a desired communication speed at all times between terminals in a network. For example, it is common that several tens of thousands or more of computers are arranged in a data center and several tens of thousands or more of lines are used in a network connecting these computers. In addition, for example, regarding supercomputers, since computer nodes are densely connected, a large number of lines are used. There are cases where a single supercomputer uses a total of about 10,000 lines or more.

In a system using a tree-type topology such as the widely-used Ethernet (registered mark), if the scale of the network is increased as described above, traffic flows often merge. As a result, congestion is more likely to occur in the network.

Meanwhile, in recent years, a communication system (flow-type communication system) is also under discussion. In this system, a group of packets each having the same combination of a packet source/destination address and a port are defined to belong to a communication flow, and a path is set per communication flow. For example, NPL 1 and 2 propose a system called OpenFlow. The flow-type communication system does not use a tree topology as a premise, and a path without congestion can be selected from among a plurality of path candidates.

However, Ethernet is widely used in existing networks, and utilization of already-installed network resources is economically important. Thus, utilization of a combination of Ethernet and the flow-type communication system is desired.

For example, PTL 1 discloses a configuration for executing a coordination operation between controllers controlling network devices compatible with the flow-type communication scheme in an environment including both network devices that are compatible with the flow-type communication scheme and network devices that are not compatible with the flow-type communication scheme.

### CITATION LIST

### Patent Literature

### [PTL 1]

Japanese Patent Kokai Publication No. JP2011-166704A [PTL 2] Japanese Patent Kokai Publication No. JP2008-301003A

### Non Patent Literature

### [NPL 1]

Nick McKeown, and seven others, “OpenFlow: Enabling Innovation in Campus Networks”, [online], [searched on Jun. 24, 2012], Internet <URL:http://www.openflow.org/documents/openflow-wp-latest.pdf>

### [NPL 2]

“OpenFlow Switch Specification” Version 1.1.0 Implemented (Wire Protocol 0x02), [online], [searched on Jun. 24, 2012], Internet <URL:http://www.openflow.org/documents/openflow-spec-v1.1.0.pdf>

### SUMMARY

### Technical Problem

The entire disclosure of the above-listed Patent Literature and Non Patent Literatures is incorporated herein by reference.

The following analysis has been given by the present invention. If a communication system using a tree-type topology as a premise such as Ethernet and a flow-type communication system that does not use a tree-type topology as a premise are used in combination, a network device that is not compatible with the flow type communication scheme arranged along a path set by the flow-type communication scheme may form a loop in the network. A loop is prohibited in a network having a tree-type topology. If a loop is detected, communication failure is caused, and as a result, normal communication cannot be executed subsequently.

In addition, an Ethernet switch has a function of automatically learning which address frame needs to be transmitted to each port. If a switch receives frames having the same address via a plurality of ingress ports, the switch relearns the address each time the switch receives frames via different ingress ports, thereupon the switch changes paths, and the network is brought in an unstable state (this is referred to as “route flapping”).

Hereinafter, a cause of route flapping will be described with reference to FIGS. 9 to 11. FIG. 9 illustrates a communication example in a normal tree topology network based on Ethernet (“STP Path” in the figure means the path using Spanning Tree Protocol.). Terminals H0 and H1 communicate with each other via Ethernet switches S0 to S2 that automatically learn addresses. A different physical link is used for each connection between a terminal and a switch, and a switch uses a different interface for connection. Each of the Ethernet switches S0 to S2 refers to a source address in a frame and automatically learns a direction in which the terminal H0 is connected. For example, if a frame having address A of the terminal H0 is inputted via port 1, a switch learns that the terminal H0 having address A is connected in the direction of port 1. Subsequently, if frames having destination address A are inputted via any one of the ports, the switch forwards the frames to port 1.

Next, communication in which a new path is added to the tree topology network illustrated in FIG. 9 will be examined. FIG. 10 illustrates an example where the Ethernet switches S0 and S2 in FIG. 9 are replaced by switches FS0 and FS2 that are compatible with a flow-type communication scheme. As illustrated in FIG. 10, if switches compatible with a flow-type communication scheme are arranged, a detailed control operation can be executed. For example, the switches forward one of the communication flows between the terminals H0 and H1 not via the Ethernet switch S1 while forwarding the other communication flow via the Ethernet switch S1. In this case, while frames having the same source address arrive at a plurality of interfaces of the switches FS0 and FS2, since the switches FS0 and FS2 do not automatically learn addresses, route flapping is not caused.

FIG. 11 illustrates an example where route flapping is caused. In FIG. 11, the Ethernet switch S0 in FIG. 9 is replaced by the switch FS0 compatible with a flow-type communication scheme, and a switch FS3 compatible with a flow-type communication scheme is arranged between the switch FS0 and the Ethernet switch S2. With the network configuration in FIG. 11, one of the communication flows from the terminal H0 to the terminal H1 can be forwarded along a path via the switch FS0 and the Ethernet switches S1 and S2 in this order, and the other communication flow can be forwarded along a path via the switches FS0 and FS3 and the Ethernet switch S2 in this order. However, with the network configuration in FIG. 11, frames having the address of the terminal H0 as a source address are inputted to the Ethernet switch S2 via different interfaces. As a result, each time the Ethernet switch S2 receives frames via different interfaces, the Ethernet switch S2 automatically learns the connection destination of the terminal H0. If route flapping is caused in this way, each time the Ethernet switch S2 receives frames, the Ethernet switch S2 automatically learns addresses frequently. As a result, processing load on the Ethernet switch S2 is increased. In addition, as a result, path change per flow and stable communication cannot be executed.

It is an object of the present invention to provide a communication system, a control apparatus, a communication method, and a program capable of preventing occurrence of a loop or route flapping in a network environment including both a switch that executes an operation of learning a packet output destination based on the source address of an incoming packet and determining the destination of the next incoming packet based on a result of the learning and a switch that does not execute the operation.

### Solution to Problem

According to a first aspect, there is provided a control apparatus that is connected to a network comprising both a first switch learning a packet output destination based on a source address of an incoming packet and determining a destination of a next incoming packet based on a result of the learning and a second switch outputting a packet in accordance with a preset path. The control apparatus comprises: a switch control unit controlling the second switch; a path examination unit determining whether communication from an arbitrary source connected to the network uses a plurality of paths; and an erroneous learning prevention processing unit executing, when a merging point of the plurality of paths is the first switch, a predetermined erroneous learning prevention process.

According to a second aspect, there is provided a communication system comprising: a network comprising both a first switch learning a packet output destination based on a source address of an incoming packet and determining a destination of a next incoming packet based on a result of the learning and a second switch outputting a packet in accordance with a preset path; and a control apparatus. The control apparatus is connected to the network and comprises: a switch control unit controlling the second switch; a path examination unit determining whether communication from an arbitrary source connected to the network uses a plurality of paths; and an erroneous learning prevention processing unit executing, when a merging point of the plurality of paths is the first switch, a predetermined erroneous learning prevention process.

According to a third aspect, there is provided a communication method used in a network comprising both a first switch learning a packet output destination based on a source address of an incoming packet and determining a destination of a next incoming packet based on a result of the learning and a second switch outputting a packet in accordance with a preset path. The communication method comprising steps of: causing a control apparatus controlling the second switch to determine whether communication from an arbitrary source connected to the network uses a plurality of paths; and causing the control apparatus to execute, when a merging point of the plurality of paths is the first switch, a predetermined erroneous learning prevention process. This method is associated with a certain machine, that is, with the control apparatus controlling the second switch.

According to a fourth aspect, there is provided a program used in a network comprising both a first switch learning a packet output destination based on a source address of an incoming packet and determining a destination of a next incoming packet based on a result of the learning and a second switch outputting a packet in accordance with a preset path. The program causes a computer mounted on a control apparatus controlling the second switch to execute processes of: determining whether communication from an arbitrary source connected to the network uses a plurality of paths; determining whether a merging point of the plurality of paths is the first switch; and executing, when the merging point of the plurality of paths is the first switch, a predetermined erroneous learning prevention process. This program can be recorded in a computer-readable (non-transient) storage medium. Namely, the present invention can be embodied as a computer program product.

### Advantageous Effects of Invention

According to the present disclosure, it is possible to prevent occurrence of a loop or route flapping in a network environment including both the above first and second switches.

### BRIEF DESCRIPTION OF DRAWINGS

FIG. 1 illustrates a network configuration according to a first exemplary embodiment of the present disclosure.

FIG. 2 illustrates a configuration of a terminal according to the first exemplary embodiment of the present disclosure.

FIG. 3 illustrates a configuration of a second switch according to the first exemplary embodiment of the present disclosure.

FIG. 4 illustrates a configuration of a control apparatus according to the first exemplary embodiment of the present disclosure.

FIG. 5 is a flow chart illustrating an operation of the control apparatus according to the first exemplary embodiment of the present disclosure.

FIG. 6 illustrates a mechanism of preventing route flapping.

FIG. 7 is a continuous diagram from FIG. 6.

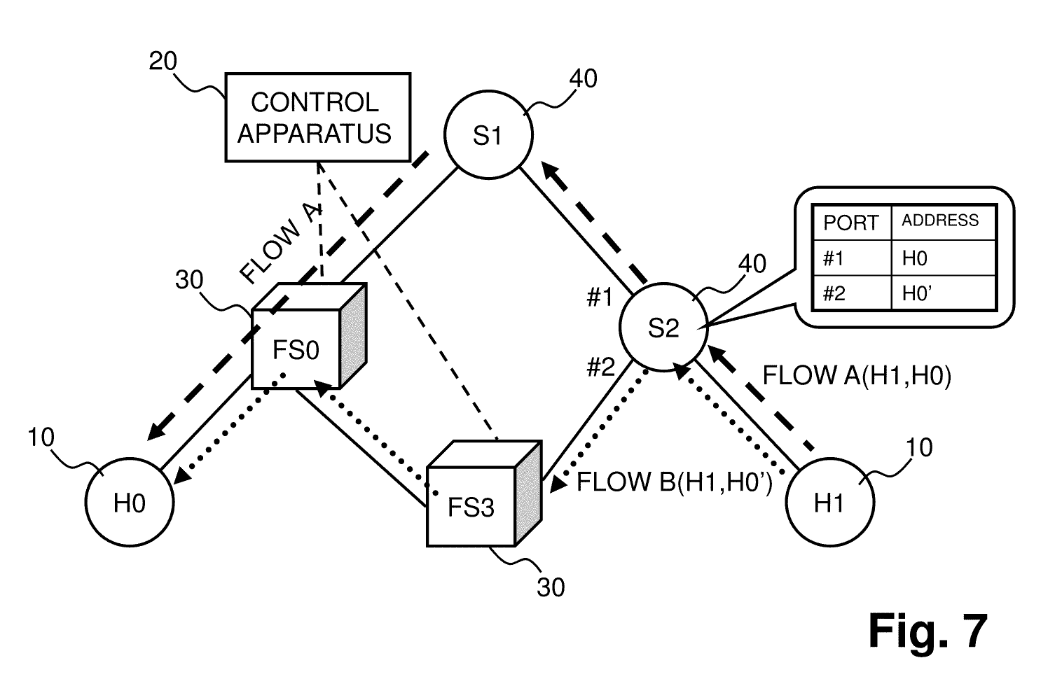

FIG. 8 illustrates a variation of the first exemplary embodiment of the present disclosure.

FIG. 9 is a diagram for illustrating a mechanism of causing route flapping.

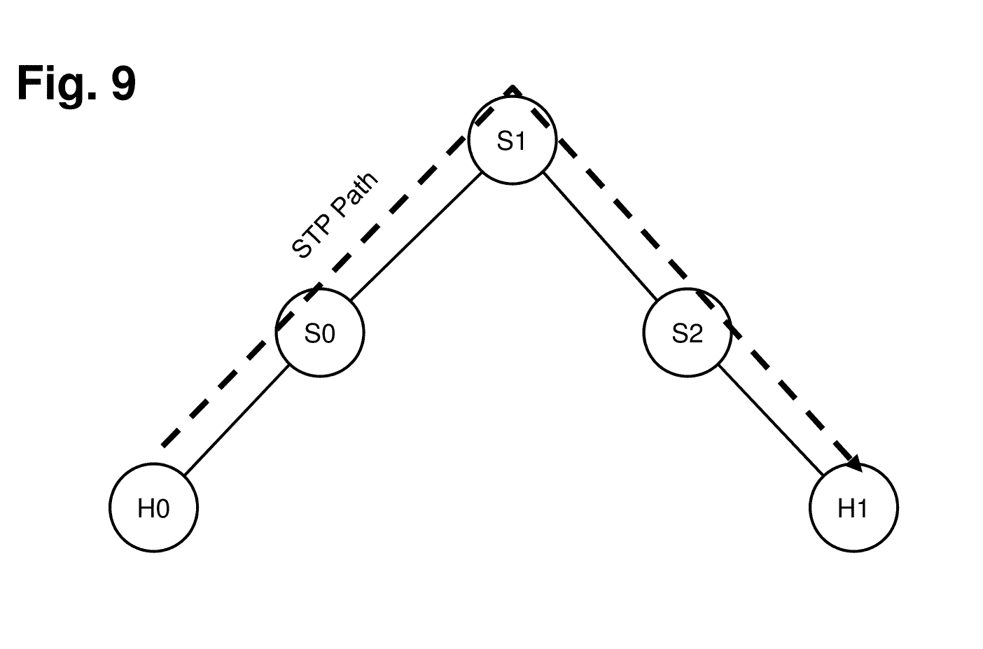

FIG. 10 is a diagram for illustrating a mechanism of causing route flapping.

FIG. 11 is a diagram for illustrating a mechanism of causing route flapping.

### DESCRIPTION OF EMBODIMENTS

First, an outline of an exemplary embodiment of the present disclosure will be described with reference to the drawings. In the following outline, various components are denoted by reference characters for the sake of convenience. Namely, the following reference characters are merely used as examples to facilitate understanding of the present disclosure, not to limit the present disclosure to the illustrated modes.

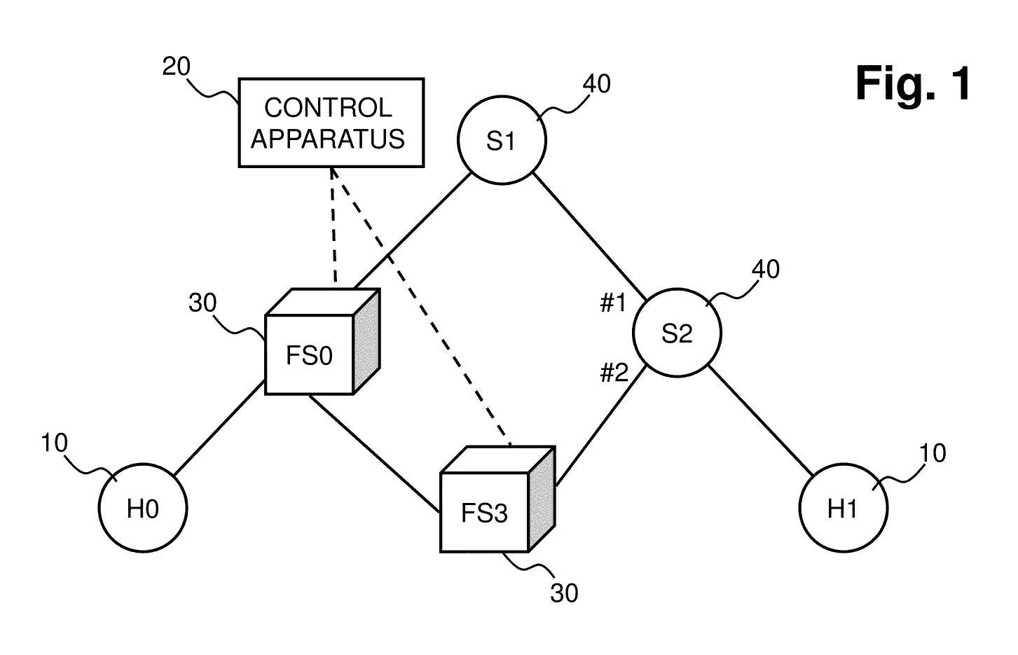

As illustrated in FIG. 1, an exemplary embodiment of the present disclosure can be realized by a configuration including a network including first switches (S1 and S2 in FIG. 1) learning a packet output destination (hereinafter, “packet” and “frame” will collectively be referred to as “packet”) based on the source address of an incoming packet and determining the destination of the next incoming packet based on a result of the learning and second switches (FS0 and FS3 in FIG. 1) outputting a packet in accordance with a preset path and a control apparatus (control apparatus 20 in FIG. 1) arranged in the network.

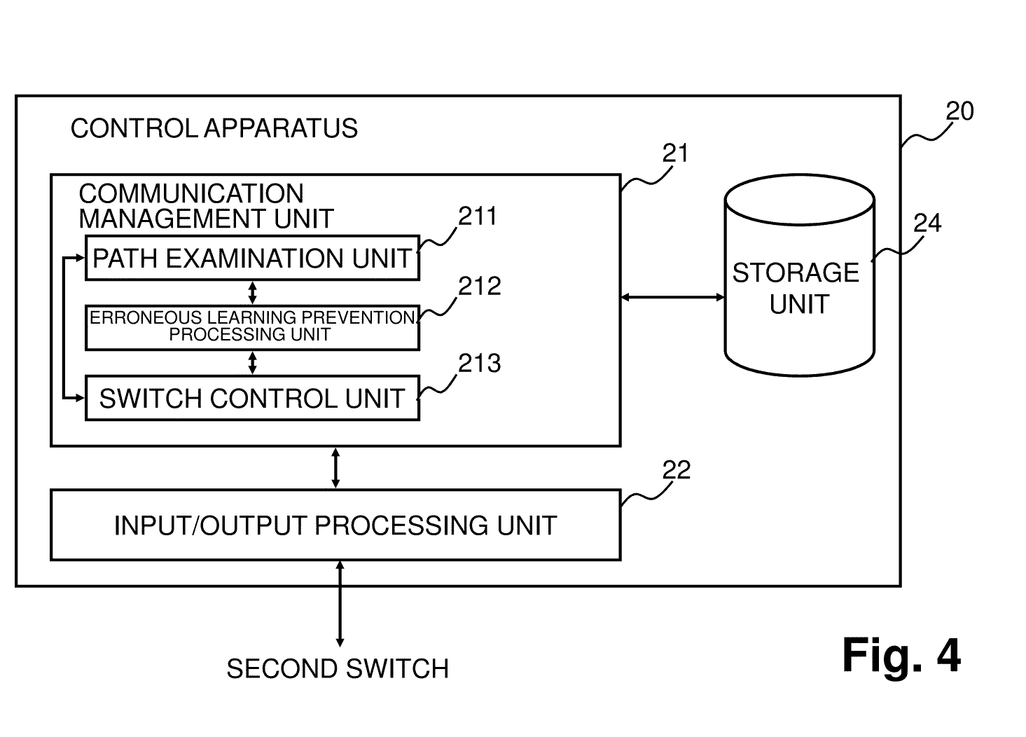

More specifically, the control apparatus (control apparatus 20 in FIG. 1) includes a switch control unit (switch control unit 213 in FIG. 4) controlling the second switches (FS0 and FS3 in FIG. 1), a path examination unit (path examination unit 211 in FIG. 4) determining whether communication from an arbitrary source connected to the network uses a plurality of paths, and an erroneous learning prevention processing unit (erroneous learning prevention processing unit 212 in FIG. 4) executing, when a merging point of the plurality of paths is any one of the first switches (S1 and S2 in FIG. 1), a predetermined erroneous learning prevention process.

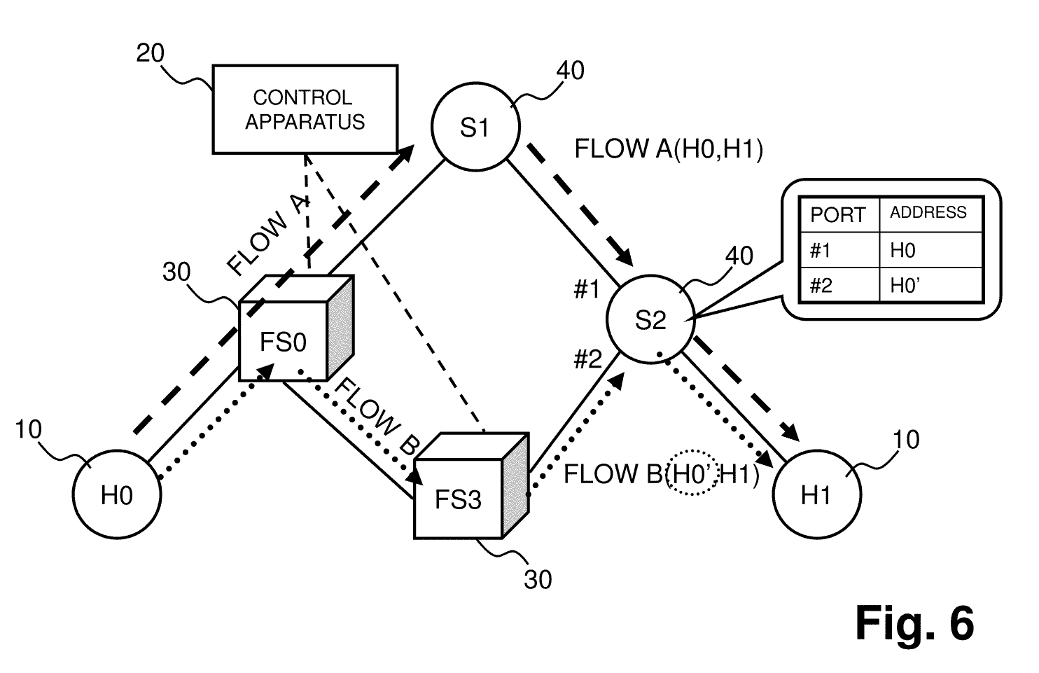

The erroneous learning prevention processing unit (erroneous learning prevention processing unit 212 in FIG. 4) executes the erroneous learning prevention process by, for example, causing a second switch (for example, FS0 or FS3 in FIG. 6) located upstream of a first switch (for example, S2 in FIG. 6) at the merging point of the paths to execute rewriting of the source address of a packet flowing along a path.

Alternatively, as the erroneous learning prevention process, the erroneous learning prevention processing unit (erroneous learning prevention processing unit 212 in FIG. 4) may recalculate and reset a path so that the merging point of the paths is not the switch S2.

As described above, in a network environment including both the above first and second switches, by causing this control apparatus (control apparatus 20 in FIG. 1) to detect a state in which erroneous learning occurs, occurrence of a loop or route flapping can be prevented.

### First Exemplary Embodiment

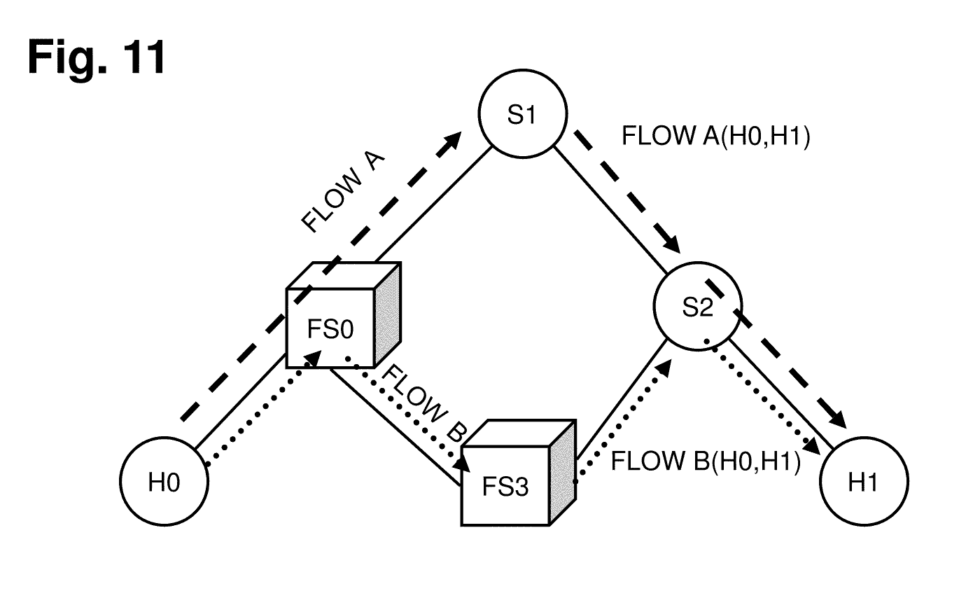

Next, a first exemplary embodiment of the present disclosure will be described in detail with reference to the drawings. FIG. 1 illustrates a network configuration according to the first exemplary embodiment of the present disclosure. In FIG. 1, a control apparatus 20 controlling second switches 30 is added to the configuration where route flapping could occur by communication between the terminals H0 and H1 illustrated in FIG. 11.

Hereinafter, the present exemplary embodiment will also be described based on an example where packets are forwarded between terminals 10 (the terminals H0 and H1) in FIG. 1 via a network including both first switches 40 and the second switches 30.

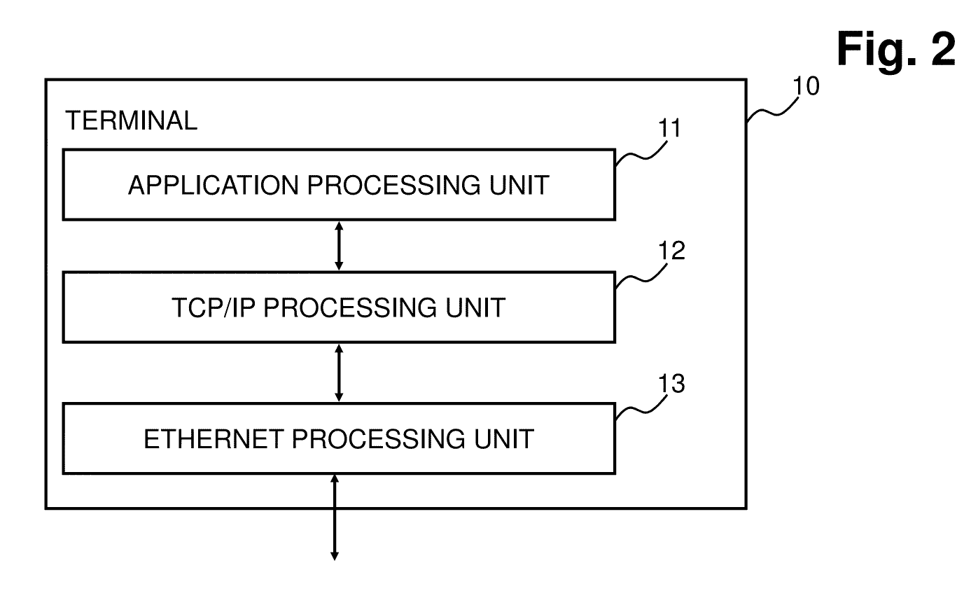

FIG. 2 is a block diagram illustrating a detailed configuration of a terminal 10. Referring to FIG. 2, the terminal 10 includes an application processing unit 11, a TCP/IP processing unit 12, and an Ethernet processing unit 13.

The application processing unit 11 outputs data transmitted from an application that operates on the terminal 10 to the TCP/IP processing unit 12. In addition, the application processing unit 11 receives data from the TCP/IP processing unit 12 and transmits the data to an application.

The TCP/IP processing unit 12 segments/packetizes data inputted from the application processing unit 11 and outputs the data to the Ethernet processing unit 13. In addition, the TCP/IP processing unit 12 processes a packet inputted from the Ethernet processing unit 13 based on TCP/IP (Transmission Control Protocol/Internet Protocol), converts the packet into data, and outputs the data to the application processing unit.

The Ethernet processing unit 13 outputs a packet inputted from the TCP/IP processing unit 12 to the network. In addition, the Ethernet processing unit 13 outputs a packet (Ethernet frame) inputted from the network to the TCP/IP processing unit 12.

The first switches according to the first exemplary embodiment of the present disclosure are general Ethernet switches (not illustrated). An Ethernet switch refers to the source address of a packet (Ethernet frame) inputted to an input interface from the network. If a learning table (which is also referred to as “MAC address table”) does not include an entry in which the input interface and the source address are associated with each other, the Ethernet switch stores an entry in which the input interface and the source address are associated with each other in the learning table. In addition, the Ethernet switch refers to the destination address of a packet. If the learning table stores an interface corresponding to the destination address, the Ethernet switch forwards the packet to the interface.

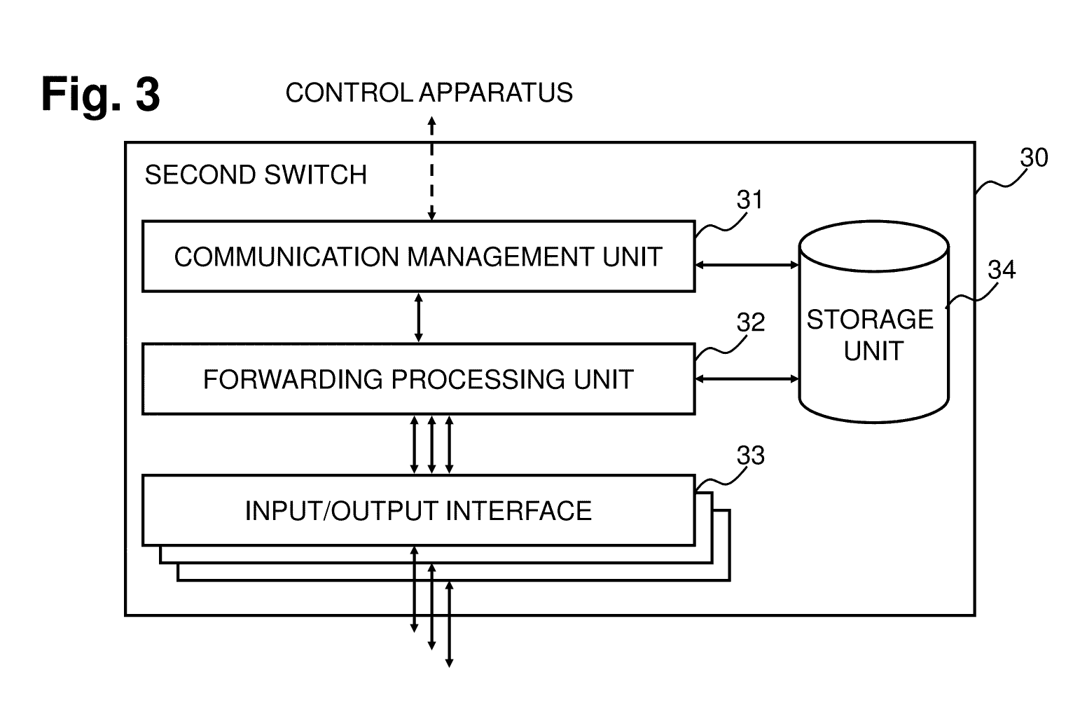

FIG. 3 illustrates a configuration of a second switch according to the first exemplary embodiment of the present disclosure. Referring to FIG. 3, the second switch includes a communication management unit 31, a forwarding processing unit 32, input/output interfaces 33, and a storage unit 34.

To execute packet forwarding that realizes a communication path determined by the control apparatus 20, the storage unit 34 stores an entry in which a matching condition that is matched against a header or the like of an incoming packet and a processing content (for example, packet forwarding from a certain input/output interface 33) that is applied to a packet matching this matching condition are associated with each other. For example, if a packet from the terminal H0 to the terminal H1 is forwarded along a path via the second switch (FS0), the second switch (FS3), and the first switch (S2) in this order, an entry in which a matching condition for identifying the packet forwarded from the terminal H0 to the terminal H1 and a processing content for forwarding the packet matching this matching condition to the first switch S2 are associated with each other is set in the second switch (FS3) on the path.

The input/output interfaces 33 are configured by a plurality of input/output ports connected to other switches or terminals in the network and exchange packets with these external devices.

The forwarding processing unit 32 searches the storage unit 34 for an entry having a matching condition matching a packet inputted from the input/output interface 33 and executes a process determined in a corresponding entry (for example, packet forwarding from a certain input/output interface). As a result of this search operation, if the storage unit 34 does not include an entry having a matching condition matching the input packet, the forwarding processing unit 32 forwards the input packet and requests the communication management unit 31 to set a new entry.

When receiving such new entry setting request from the forwarding processing unit 32, the communication management unit 31 transmits information about the input packet to the control apparatus 20 and requests the control apparatus 20 to set a new entry. When receiving an entry for forwarding in accordance with a predetermined path (for example, Path2 (H0, H1)={FS0, FS3, S2}) from the control apparatus 20, the communication management unit 31 stores the entry in the storage unit 34 and outputs the input packet to the forwarding processing unit 32, again.

As the above second switch, an OpenFlow switch in NPL 1 and 2 having a flow table storing flow entries in the storage unit 34 can be used.

FIG. 4 illustrates a configuration of the control apparatus according to the first exemplary embodiment of the present disclosure. Referring to FIG. 4, the control apparatus includes a communication management unit 21, an input/output processing unit 22, and a storage unit 24.

The input/output processing unit 22 processes input and output of control messages exchanged with the second switches 30, including the above new entry setting requests and the responses thereto.

The storage unit 24 stores a network topology configured by the first and second switches, calculated path information, and contents of the path control entries stored in the second switches. The control apparatus 20 may automatically collect the network topology by using various types of reading protocols or an operator may set the network topology.

The communication management unit 21 includes a switch control unit 213, an erroneous learning prevention processing unit 212, and a path examination unit 211. When receiving a request for setting a new entry from a second switch 30, the switch control unit 213 of the communication management unit 21 refers to the network topology stored in the storage unit 24 and calculates a communication path. In addition, the communication management unit 21 generates new entries for realizing packet forwarding along the calculated communication path.

The path examination unit 211 refers to the storage unit 24 and determines whether a path having the same source and destination as those of the calculated path has already been set.

If a path having the same source and destination as those of the calculated path has already been set, the erroneous learning prevention processing unit 212 determines whether a merging point of the two or more paths is a first switch 40. If the merging point of the two or more paths is a first switch 40, the erroneous learning prevention processing unit 212 adds an entry for executing a process for rewriting a packet header to a predetermined content as an entry that is set in a second switch 30 located upstream of the first switch 40 at the merging point of the paths, among the new entries for realizing packet forwarding along the calculated communication path. In addition, among the second switches 30 along the calculated path, the erroneous learning prevention processing unit 212 rewrites a matching condition of the entry that is set in the second switch 30 that receives the rewritten packet header so that the matching condition matches the rewritten packet header.

If a path having the same source and destination as those of the calculated path is not set, the above entry operation is omitted. In addition, while a path having the same source and destination as those of the calculated path has already been set, if the merging point is not the first switch 40, the above entry operation is omitted.

The communication management unit 21 according to the present exemplary embodiment transmits the new entry generated in the above way to the second switch 30.

The above control apparatus 20 can be realized by adding functions corresponding to the above erroneous learning prevention processing unit 212 and path examination unit 211 to an OpenFlow controller controlling OpenFlow switches in NPL 1 and 2.

In addition, each unit (processing means) of the control apparatus 20 illustrated in FIG. 4 can be realized by a computer program causing a computer constituting the control apparatus 20 to use hardware of the computer and to execute a corresponding process of the above processing.

Next, an operation according to the present exemplary embodiment will be described in detail with reference to the drawings. The following description will be made assuming that a path for forwarding a packet from the terminal H0 to the terminal H1 via the switches FS0 to S2 in FIG. 1 in this order has already been set.

The above path can be expressed as below:

Path1(H0,H1)={FS0,S1,S2}

In this equation, H0 represents the IP address and the MAC address of the terminal H0 serving as a source and H1 represents the IP address and the MAC address of the terminal H1 serving as a destination.

In addition, the following description will be made, assuming that a new communication flow has been generated between the terminals H0 and H1, a request for setting a new entry has been transmitted from the second switch (FS0), and the next path has been calculated as a new path.

Path2(H0,H1)={FS0,FS3,S2}

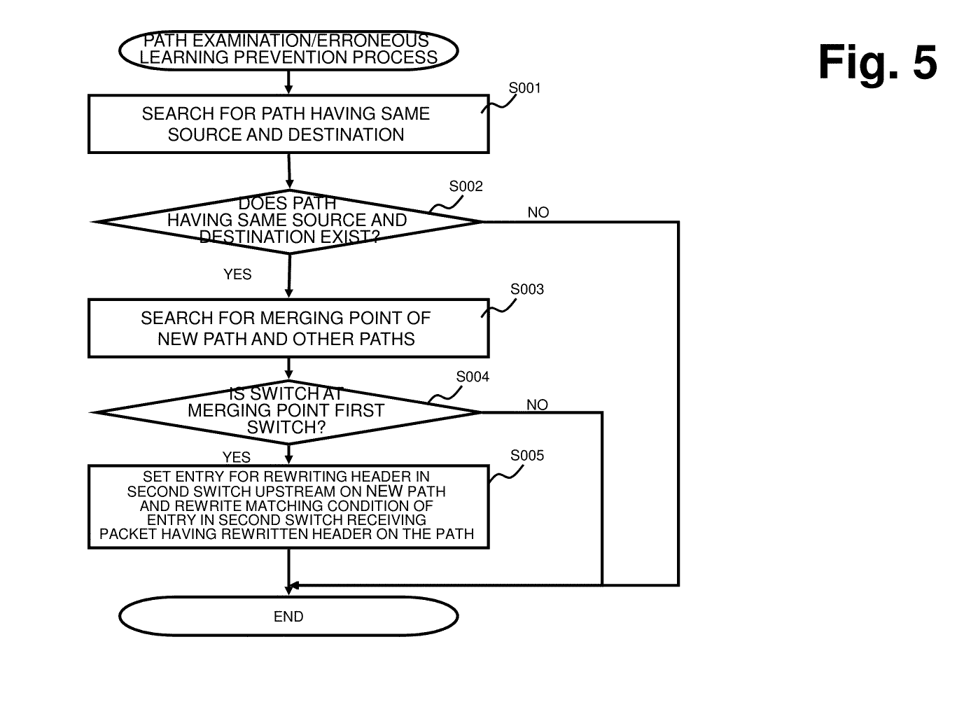

FIG. 5 is a flow chart illustrating a flow of a path examination and an erroneous learning prevention process executed by the control apparatus according to the first exemplary embodiment of the present disclosure. Referring to FIG. 5, the control apparatus 20 searches the storage unit 24 for a path having the same source and destination as those of a path Path2 used by the newly-generated communication (step S001). In this example, the control apparatus 20 detects Path1 having the same combination of H0 and H1 (YES in step S002).

Next, the control apparatus 20 checks Path1 and Path2 to search for a traffic merging point (step S003). As illustrated in FIG. 1, while both Path1 and Path2 use the second switch (FS0), Path1 and Path2 use different switches after the second switch (FS0). More specifically, after the second switch (FS0), Path1 uses the first switch (S1) and Path2 uses the second switch (FS3), and subsequently, both Path1 and Path2 use the same switch, that is, the first switch (S2). Thus, the control apparatus 20 determines that the merging point of the two traffic flows is the first switch (S2) (YES in step S004). The control apparatus 20 may determine that the merging point is the first switch (S2) by referring to the network topology stored in the storage unit 24 or by querying the switch at the merging point about the switch type thereof each time.

Next, since the merging point switch is the first switch (S2), the control apparatus 20 sets an entry in the second switch (FS0) located upstream of the first switch (S2) on the path. With this entry, when the second switch (FS0) receives a packet belonging to the newly-generated communication, the second switch (FS0) rewrites the header of the packet. In addition, if there is a second switch 30 that receives a packet having the rewritten header on the path (the second switch FS3 if the switch executing rewriting is the second switch FS0), the control apparatus 20 rewrites a matching condition of the entry set in the second switch 30.

For example, as illustrated in FIG. 6, the control apparatus 20 adds an entry for rewriting the source IP address (for example, “IP_H0”) in a header of a packet from the terminal H0 to the terminal H1 to a temporary IP address (for example, “IP_H0′”) to an upstream second switch (FS0 or FS3). In this operation, the control apparatus 20 may add an entry for rewriting the destination IP address (for example, “IP_H0′”) in a header of the packet from the terminal H1 to the terminal H0 back to the actual IP address (for example, “IP_H0”).

Consequently, among the packets from the terminal H0 to the terminal H1, the first switch (S2) at the merging point can separately learn a flow (flow A in FIG. 6) using Path1 and a flow (flow B in FIG. 6) using Path2, as illustrated in FIG. 6.

In addition, when receiving packets from the terminal H1 to the terminal H0, the first switch (S2) at the merging point refers to the learning table in which the above paths are separately learned and forwards packets whose destination is H0 to a connection port of the first switch (S1) and packets whose destination is H0′ to a connection port of the second switch (FS3).

As described above, by causing a second switch upstream of the merging point to rewrite a header, occurrence of route flapping can be prevented.

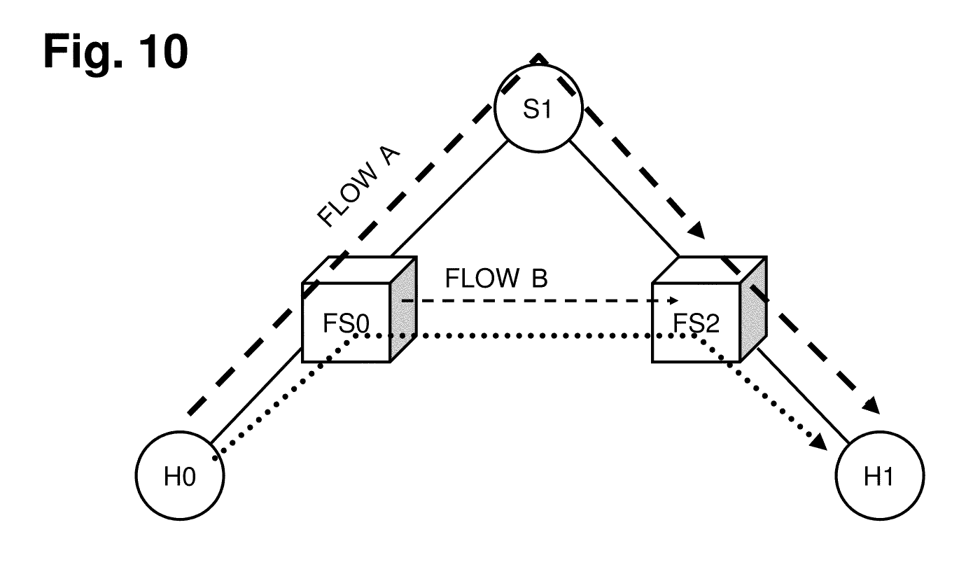

If the control apparatus 20 determines that the merging point of the two traffic flows is not the first switch (S2) (NO in step S004), the communication is executed as illustrated in FIG. 10. Thus, the erroneous learning prevention process is not necessary.

As described above, according to the present exemplary embodiment, occurrence of route flapping can be prevented, and an unstable network operation can be prevented.

While an exemplary embodiment of the present disclosure has thus been described, the present disclosure is not limited thereto. Further variations, substitutions, and adjustments can be made without departing from the basic technical concept of the present disclosure. For example, the network configuration and the number of the first and second switches in the above exemplary embodiment are merely used as examples. Namely, the present disclosure is not limited to the above numbers.

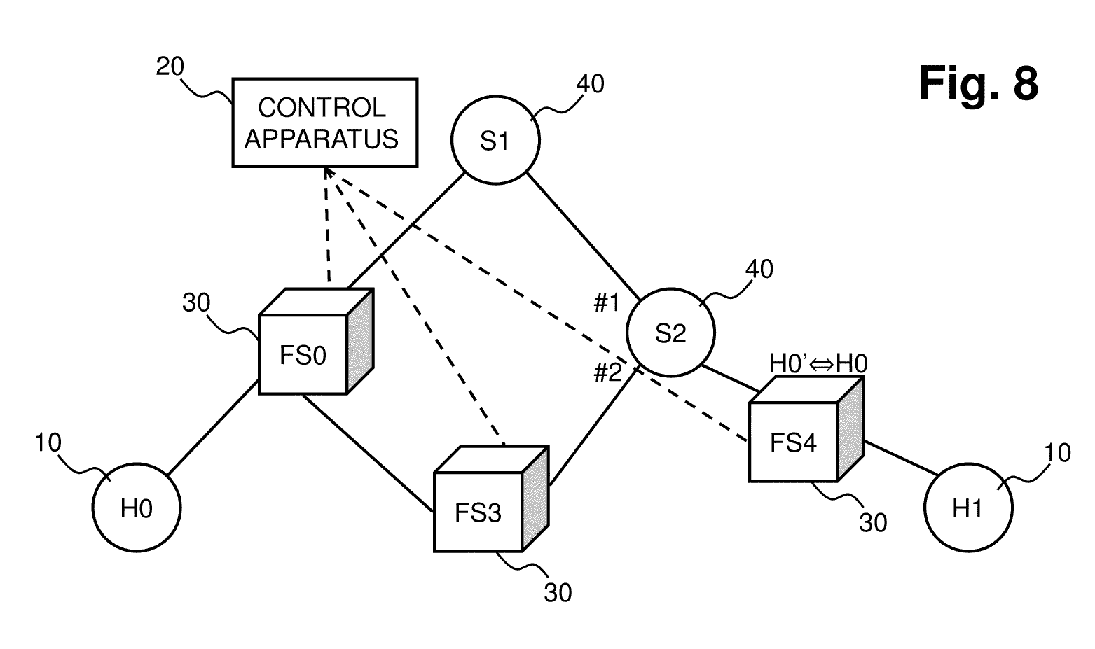

In addition, for example, as illustrated in FIG. 8, a configuration in which a second switch (FS4) connected to the terminal H1 is arranged at an end of the network can preferably be adopted. In this way, after the second switch (FS4) is caused to recover the header rewritten in the above step S005, the second switch (FS4) can forward the packet to the terminal H1 (note that a matching condition for distinguishing flows A and B needs to be set). In addition, by causing the second switch (FS4) to convert packets transmitted from the terminal H1 to the terminal H0, the first switch (S2) can forward the packets to suitable forwarding destinations.

The above exemplary embodiment has been described based on an example where the IP address is rewritten. However, it is needless to say that the MAC address or both the MAC address and the IP address may be written.

In addition, the above exemplary embodiment has been described based on an example where a path examination and an erroneous learning prevention process are executed when a new communication flow is generated. However, instead of executing a path examination and an erroneous learning prevention process when a new communication flow is generated, existing paths may be checked against each other at arbitrary timing such as at certain time intervals, to execute the path examination and the erroneous learning prevention processing.

Preferred forms of the present disclosure will now be summarized as follows.

### <Mode 1>

(See the control apparatus according to the first aspect)

### <Mode 2>

The control apparatus, it is preferred that, as the predetermined erroneous learning prevention process, a second switch upstream of a first switch located at the merging point of the paths is caused to execute rewriting of a source address of a packet flowing along one of the paths.

### <Mode 3>

The control apparatus, it is preferred that, as the predetermined erroneous learning prevention process, a MAC address or both a MAC address and an IP address of a packet flowing along one of the paths are rewritten.

### <Mode 4>

(See the communication system according to the second aspect)

### <Mode 5>

(See the communication method according to the third aspect)

### <Mode 6>

The communication method, it is preferred that the communication method further comprises:
causing, as the predetermined erroneous learning prevention process, a second switch upstream of a first switch located at the merging point of the paths to execute rewriting of a source address of a packet flowing along one of the paths.

### <Mode 7>

The communication method, it is preferred that the communication method further comprises:
rewriting, as the predetermined erroneous learning prevention process, a MAC address or both a MAC address and an IP address.

### <Mode 8>

(See the program according to the fourth aspect)

### <Mode 9>

A computer-readable storage medium storing a program used in a network comprising both a first switch learning a packet output destination based on a source address of an incoming packet and determining a destination of a next incoming packet based on a result of the learning and a second switch outputting a packet in accordance with a preset path, the program causing a computer mounted on a control apparatus controlling the second switch to execute processes of:

determining whether communication from an arbitrary source connected to the network uses a plurality of paths;

determining whether a merging point of the plurality of paths is the first switch; and

executing, when the merging point of the plurality of paths is the first switch, a predetermined erroneous learning prevention process.

The entire disclosures of the above PTL and NPL are incorporated herein by reference thereto. Modifications and adjustments of the exemplary embodiments and examples are possible within the scope of the overall disclosure (including the claims) of the present invention and based on the basic technical concept of the present invention. Various combinations and selections of various disclosed elements (including the elements in each of the claims, exemplary embodiments, examples, drawings, etc.) are possible within the scope of the claims of the present invention. That is, the present invention of course includes various variations and modifications that could be made by those skilled in the art according to the overall disclosure including the claims and the technical concept.

### REFERENCE SIGNS LIST

H0, H1 terminal
FS0, FS3, FS4 second switch
S1, S2 first switch
10 terminal
11 application processing unit
12 TCP/IP processing unit
13 Ethernet processing unit
20 control apparatus
21 communication management unit
22 input/output processing unit
24 storage unit
30 second switch
31 communication management unit
32 forwarding processing unit
33 input/output interface
34 storage unit
40 first switch
211 path examination unit
212 erroneous learning prevention processing unit
213 switch control unit

What is claimed is:

1. A control apparatus, wherein the control apparatus is connected to a network comprising both a first switch learning a packet output destination based on a source address of an incoming packet and determining a destination of a next incoming packet based on a result of the learning and a second switch outputting a packet in accordance with a preset path, the control apparatus comprising:
a switch control unit controlling the second switch;
a path examination unit determining whether communication from an arbitrary source connected to the network uses a plurality of paths; and
an erroneous learning prevention processing unit executing, when a merging point of the plurality of paths comprises the first switch, a predetermined erroneous learning prevention process.

2. The control apparatus according to claim 1;
wherein, as the predetermined erroneous learning prevention process, a second switch upstream of a first switch located at the merging point of the paths is caused to execute rewriting of a source address of a packet flowing along one of the paths.

3. The control apparatus according to claim 2;
wherein, as the predetermined erroneous learning prevention process, a MAC address or both a MAC address and an IP address of a packet flowing along one of the paths are rewritten.

4. A communication system, comprising:
a network comprising both a first switch learning a packet output destination based on a source address of an incoming packet and determining a destination of a next incoming packet based on a result of the learning and a second switch outputting a packet in accordance with a preset path; and
a control apparatus;
wherein the control apparatus is connected to the network and comprises:
a switch control unit controlling the second switch;
a path examination unit determining whether communication from an arbitrary source connected to the network uses a plurality of paths; and
an erroneous learning prevention processing unit executing, when a merging point of the plurality of paths comprises the first switch, a predetermined erroneous learning prevention process.

5. A communication method, comprising: using a network comprising both a first switch learning a packet output destination based on a source address of an incoming packet and determining a destination of a next incoming packet based on a result of the learning and a second switch outputting a packet in accordance with a preset path, the communication method comprises:
causing a control apparatus controlling the second switch to determine whether communication from an arbitrary source connected to the network uses a plurality of paths; and
causing the control apparatus to execute, when a merging point of the plurality of paths comprises the first switch, a predetermined erroneous learning prevention process.

6. The communication method according to claim 5, comprising:
causing, as the predetermined erroneous learning prevention process, a second switch upstream of a first switch located at the merging point of the paths to execute rewriting of a source address of a packet flowing along one of the paths.

7. The communication method according to claim 6, comprising:
rewriting, as the predetermined erroneous learning prevention process, a MAC address or both a MAC address and an IP address.

8. A program, wherein the program is adapted to be used in a network comprising both a first switch learning a packet output destination based on a source address of an incoming packet and determining a destination of a next incoming packet based on a result of the learning and a second switch outputting a packet in accordance with a preset path;
the program causing a computer mounted on a control apparatus controlling the second switch to execute processes of:
determining whether communication from an arbitrary source connected to the network uses a plurality of paths;
determining whether a merging point of the plurality of paths comprises the first switch; and
executing, when the merging point of the plurality of paths comprises the first switch, a predetermined erroneous learning prevention process.

9. A computer-readable storage medium storing a program wherein the program is adapted to be used in a network comprising both a first switch learning a packet output destination based on a source address of an incoming packet and determining a destination of a next incoming packet based on a result of the learning and a second switch outputting a packet in accordance with a preset path, the program causing a computer mounted on a control apparatus controlling the second switch to execute processes of:
determining whether communication from an arbitrary source connected to the network uses a plurality of paths;
determining whether a merging point of the plurality of paths comprises the first switch; and
executing, when the merging point of the plurality of paths comprises the first switch, a predetermined erroneous learning prevention process.
